(19) United States
(12) Patent Application Publication
(10) Pub. No.: US 2025/0155160 A1
(43) Pub. Date: May 15, 2025

(54) WATER HEATING DEVICE

(71) Applicants: QINGDAO JIAONAN HAIER WASHING MACHINE CO., LTD., Qingdao (CN); QINGDAO HAIER WASHING MACHINE CO., LTD., Qingdao (CN); HAIER SMART HOME CO., LTD., Qingdao (CN)

(72) Inventors: Zhiqiang Zhao, Qingdao (CN); Sheng Xu, Qingdao (CN); Peishi Lv, Qingdao (CN)

(21) Appl. No.: 18/840,059

(22) PCT Filed: Jan. 29, 2023
(86) PCT No.: PCT/CN2023/073658

§ 371 Date: Aug. 20, 2024

(30) Foreign Application Priority Data
Feb. 21, 2022 (CN) 202210157045.4
Feb. 21, 2022 (CN) 202210158339.9
Feb. 25, 2022 (CN) 202210179749.1
Feb. 25, 2022 (CN) 202210190850.7

(51) Int. Cl. F24H 1/12; D06F 39/04; D06F 39/40; H05B 3/44

(52) U.S. Cl. CPC F24H 1/121; D06F 39/04; D06F 39/40; H05B 3/44; F24H 2250/02; H05B 2203/021

(57) ABSTRACT

A water heating device, relating to the technical field of clothes processing apparatuses. In order to solve the problem of poor water heating effect of existing water heating devices, the water heating device comprises an outer shell (1), a water inlet (11) and an outlet (12) are formed in the outer shell, heating pipes are arranged in the outer shell, superconducting material layers are arranged on the outer surfaces of the heating pipes, and the water inlet and the outlet communicate with two ends of the heating pipes respectively. Cold water flows into the heating pipes, the superconducting material layers heat the water flowing into the heating pipes, and then hot water or steam is discharged from the outlet and enters a clothes containing tub, thus providing hot water for clothes washing or providing steam for clothes care. The superconducting material layers have the advantages of small thermal resistance, high heat exchange efficiency and power saving, and can achieve rapid heat dissipation and immediate cooling after power failure. Therefore, water can be instantly heated, and can be fed and discharged simultaneously without water residues in the heating pipes, and the contact between water and the heating pipes is more uniform and the staying time is longer, so that the generation speed of hot water or steam is higher, the heat loss is smaller, and the efficiency is higher.

### CROSS REFERENCE TO RELATED APPLICATIONS

The present application claims priority from Chinese patent applications No. CN202210158339.9 and No. CN202210157045.4 filed on Feb. 21, 2022, as well as Chinese patent applications No. CN202210190850.7 and No. CN202210179749.1 filed on Feb. 25, 2022, the entire disclosure of which is incorporated herein by reference.

### FIELD

The present disclosure relates to the technical field of clothing treatment apparatuses, and specifically provides a water heating device.

### BACKGROUND

Existing clothing treatment apparatuses, such as washing-drying integrated machines or clothing care machines, are internally provided with a water heating device to heat washing water or generate steam after heating the water to remove wrinkles. The existing water heating devices typically use electric heating tubes or ceramic heating elements to heat the water; however, the temperature controllability of the existing electric heating tubes is poor and the heat loss is too high, and the ceramic PCT heating elements have problems such as slow temperature rise, low thermal conductivity efficiency, and severe attenuation. In the prior art, superconducting heating wires are provided in the water heating device to heat the water; however, the flow rate of water is fast, the contact time of water with the superconducting heating wires is short, and the heating of the water is not uniform enough, thus resulting in poor water heating effect.

Accordingly, there is a need for a new water heating device in the art to solve the problem of poor water heating effect of existing water heating devices.

### SUMMARY

The present disclosure aims to solve the above technical problem, namely, to solve the problem of poor water heating effect of existing water heating devices.

In a first aspect, the present disclosure provides a water heating device, which includes an outer shell, on which a water inlet and an outlet are provided; a heating tube is provided inside the outer shell, a superconducting material layer is provided on an outer surface of the heating tube, and the water inlet and the outlet are respectively communicated with two ends of the heating tube.

In a preferred technical solution of the water heating device described above, the outer shell includes a box and a cover that can open and close the box; the water inlet is arranged on one side wall of the box, the outlet is arranged on the other side wall opposite to the water inlet, and the heating tube is arranged inside the box.

In a preferred technical solution of the water heating device described above, a spiral structural member is provided inside the heating tube.

In a preferred technical solution of the water heating device described above, a first partition and a second partition are provided inside the box; the first partition forms a first water chamber with the side wall on the side of the water inlet, and the second partition forms a second water chamber with the side wall on the side of the outlet; the heating tube is arranged between the first partition and the second partition, with a first tube hole being provided on the first partition and a second tube hole being provided on the second partition; and the two ends of the heating tube are respectively arranged in the first tube hole and the second tube hole.

In a preferred technical solution of the water heating device described above, the heating tube is a heating glass tube, the number of the heating glass tube is multiple, and the multiple heating glass tubes are arranged side by side inside the box.

In a preferred technical solution of the water heating device described above, a third partition is provided inside the first water chamber, and a fourth partition is provided inside the second water chamber; the third partition divides the first water chamber into multiple first water sub-chambers, the fourth partition divides the second water chamber into multiple second water sub-chambers, and the multiple heating glass tubes are communicated in series through the first water sub-chambers and the second water sub-chambers.

In a preferred technical solution of the water heating device described above, one ends of the multiple heating glass tubes are connected in series using a first wire to form a live wire terminal, and the other ends of the multiple heating glass tubes are connected in series using a second wire to form a neutral wire terminal.

In a preferred technical solution of the water heating device described above, sealing rings are provided between the first tube hole and the heating tube, as well as between the second tube hole and the heating tube.

In a preferred technical solution of the water heating device described above, the water inlet and the outlet are diagonally arranged.

In a preferred technical solution of the water heating device described above, the spiral structural member is a spiral spring.

It can be understood by those skilled in the art that the water heating device of the present disclosure includes an outer shell, on which a water inlet and an outlet are provided; a heating tube is provided inside the outer shell, a superconducting material layer is provided on an outer surface of the heating tube, and the water inlet and the outlet are respectively communicated with two ends of the heating tube.

In a case where the above technical solutions are adopted, by providing a superconducting material layer on the outer surface of the heating tube in the water heating device of the present disclosure, the heat of the superconducting material layer is transferred to the heating tube, so as to heat the water inside the heating tube. Specifically, the water heating device of the present disclosure has a dual function of generating hot water or steam by setting different heating temperatures. When using the water heating device, the water inlet of the water heating device is connected to a water source, and the outlet is communicated with a clothing containing cylinder of the washing-drying integrated machine. Cold water flows into the heating tube, and the superconducting material layer heats the water flowing into the heating tube. Then, hot water or steam is discharged from the outlet into the clothing containing cylinder, providing hot water for clothing washing or providing steam for clothing care. The superconducting material layer has the advantages of low thermal resistance, high heat exchange efficiency, and power saving. Moreover, due to its characteristics of rapid heat dissipation and cooling upon power outage, the superconducting material layer can automatically maintain a constant temperature and has good temperature controllability. Therefore, it can heat the water instantly when the water flows through, with water flowing in and flowing out simultaneously, and there is no any residual water or scale in the heating tube. In addition, the superconducting material layer can cool down quickly after power is cut off, making water temperature control more accurate. The water heating device of the present disclosure separates water from electricity through the heating tube, which is safe and reliable. The outer shell seals the heating tube inside, so that users can use it without the possibility of getting an electric shock, achieving higher safety performance of household appliances. Due to the annular contact between water and the heating tube, the heating of water is more uniform, and the water stays in the heating tube for a longer time. The heating tube can also provide a certain heat preservation effect, so the generation rate of hot water or steam is faster, the heat loss is smaller, and the efficiency is higher.

### BRIEF DESCRIPTION OF DRAWINGS

Preferred embodiments of the present disclosure will be described below in connection with the accompanying drawings, in which:

FIG. 1 is a perspective structural view of the water heating device of the present disclosure;

FIG. 2 is a side structural view of the water heating device of the present disclosure;

FIG. 3 is a cross-sectional structural view at A-A in FIG. 2;

FIG. 4 is a front structural view of the box of the water heating device of the present disclosure; and

FIG. 5 is a perspective structural view of the box of the water heating device of the present disclosure.

### LIST OF REFERENCE SIGNS

1: outer shell; 11: water inlet; 12: outlet; 13: box; 131: first partition; 1311: first tube hole; 132: second partition; 1321: second tube hole; 133: third partition; 1331: first water sub-chamber; 134: fourth partition; 1341: second water sub-chamber; 135: first water chamber; 136: second water chamber; 137: sealing ring; 14: cover; 2: heating glass tube; 3: spiral structural member; 4: live wire terminal; 5: neutral wire terminal.

### DETAILED DESCRIPTION

Preferred embodiments of the present disclosure will be described below with reference to the accompanying drawings. It should be understood by those skilled in the art that these following embodiments are only used to explain the technical principle of the present disclosure, and are not intended to limit the scope of protection of the present disclosure. These embodiments can be adjusted by those skilled in the art as needed to adapt to specific application scenes. For example, although the present application is described in connection with a washing-drying integrated machine, this is not limiting. The water heating device of the present disclosure can be applied to other clothing treatment apparatuses, such as washing machines, dryers, or clothing care machines, and can also be applied to apparatuses that require hot water or steam other than the clothing treatment apparatuses.

It should be noted that in the description of the present disclosure, terms indicating directional or positional relationships, such as “upper”, “inner”, “outer” and the like, are based on the directional or positional relationships shown in the accompanying drawings. They are only used for ease of description, and do not indicate or imply that the device or element must have a specific orientation, or must be constructed or operated in a specific orientation; therefore, they should not be considered as limitations to the present disclosure. In addition, terms “first”, “second”, “third” and “fourth” are only used for descriptive purpose, and should not be understood as indicating or implying relative importance.

In addition, it should also be noted that in the description of the present disclosure, unless otherwise clearly specified and defined, terms “install” and “connect” should be understood in a broad sense; for example, the connection may be a fixed connection, or a detachable connection, or an integral connection; it may be a mechanical connection; it may be a direct connection, or an indirect connection implemented through an intermediate medium, or internal communication between two elements. For those skilled in the art, the specific meaning of the above terms in the present disclosure can be interpreted according to specific situations.

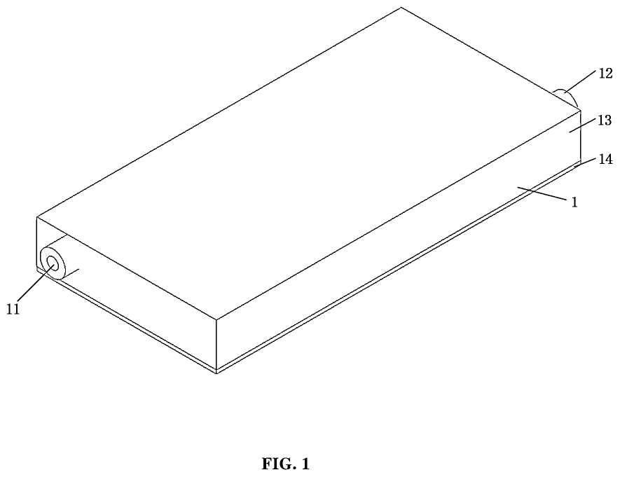

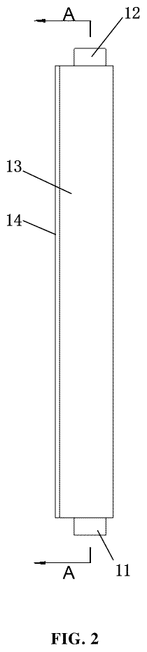

As shown in FIGS. 1 to 3, in order to solve the problem of poor water heating effect of existing water heating devices, the water heating device of the present disclosure includes an outer shell 1, which is provided with a water inlet 11 and an outlet 12. The outer shell 1 is internally provided with a heating tube, which is preferably a heating glass tube 2. An outer surface of the heating glass tube 2 is provided with a superconducting material layer, and preferably, the outer surface of the heating glass tube 2 is coated with a superconducting material film. The water inlet 11 and the outlet 12 are respectively communicated with two ends of the heating glass tube 2. The superconducting material layer consists of twenty eight discovered elements such as niobium, nickel, chromium, as well as thousands of alloys and compounds, such as niobium zirconium alloy, niobium titanium alloy, and nickel chromium alloy. It should be noted that the superconducting material layer can be coated on the outer surface of the heating glass tube 2, or the superconducting material layer can be directly fixed on the outer surface of the heating glass tube 2. Therefore, there is no any restriction on the form of fixing the superconducting material layer on the heating glass tube 2, as long as the superconducting material layer can provide heat for the heating glass tube 2. Those skilled in the art can set it by themselves according to their needs.

The above arrangement has the following advantages: by providing the superconducting material layer on the outer side of the heating glass tube 2 in the water heating device of the present disclosure, the heat of the superconducting material layer is transferred to the heating glass tube 2, so as to heat the water inside the heating glass tube 2. Specifically, the water heating device of the present disclosure has a dual function of generating hot water or steam by setting different heating temperatures. When using the water heating device, the water inlet 11 of the water heating device is communicated with a water source, and the outlet 12 is communicated with a clothing containing cylinder of the washing-drying integrated machine. Cold water flows into the heating glass tube 2, and the superconducting material layer heats the water flowing into the heating glass tube 2. Then, hot water or steam is discharged from the outlet 12 into the clothing containing cylinder, providing hot water for clothing washing or providing steam for clothing care. The superconducting material layer has the advantages of low thermal resistance, high heat exchange efficiency, and power saving. Moreover, due to its characteristics of rapid heat dissipation and cooling upon powering off, the superconducting material layer can automatically maintain a constant temperature and has good temperature controllability. Therefore, it can heat the water instantly when the water flows through the heating glass tube 2, with water flowing in and flowing out simultaneously, and there is no any residual water or scale in the heating glass tube 2. In addition, the superconducting material layer can cool down quickly after power is cut off, making water temperature control more accurate. The water heating device of the present disclosure separates water from electricity through the heating glass tube, which is safe and reliable. The outer shell seals the heating glass tube inside, so that users can use it without the possibility of getting an electric shock, achieving higher safety performance of household appliances. Due to the annular contact between water and the heating glass tube 2, the heating of water is more uniform, and the water stays in the heating glass tube 2 for a longer time. The heating glass tube can also provide a certain heat preservation effect, so the generation rate of hot water or steam is faster, the heat loss is smaller, and the efficiency is higher.

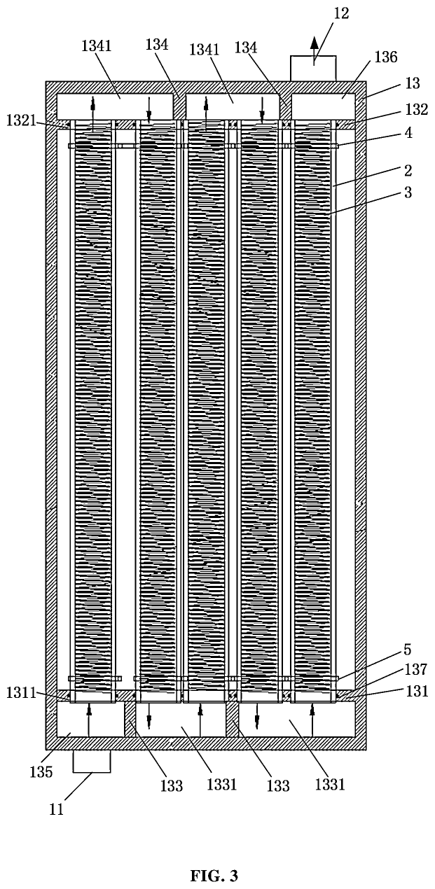

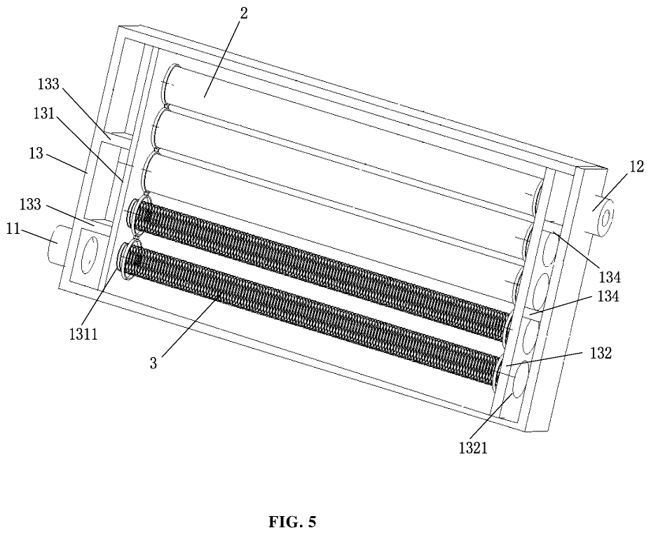

As shown in FIGS. 1 to 3, where the directions of arrows in FIG. 3 indicate a flow direction of water, in a possible embodiment, the outer shell 1 is of a cuboid structure. Specifically, the outer shell 1 includes a box 13 and a cover 14 that can open and close the box 13. The cover 14 is sealed and connected with the box 13. Preferably, both the cover 14 and the box 13 are made of polymer materials, and the cover 14 and the box 13 are sealed and connected by ultrasonic welding or melting. The water inlet 11 is arranged on one side wall of the box 13, and the outlet 12 is arranged on the other side wall opposite to the water inlet 11. Preferably, the water inlet 11 and the outlet 12 are diagonally arranged. Further, the box 13 is internally provided with a first partition 131 and a second partition 132. The first partition 131 forms a first water chamber 135 with the side wall on the side of the water inlet 11, and the second partition 132 forms a second water chamber 136 with the side wall on the side of the outlet 12. The heating glass tube 2 is arranged between the first partition 131 and the second partition 132, with a first tube hole 1311 being provided on the first partition 131 and a second tube hole 1321 being provided on the second partition 132. The heating glass tube 2 is a straight tube, and two ends of the heating glass tube 2 are respectively arranged in the first tube hole 1311 and the second tube hole 1321, so that the heating glass tube 2 is suspended in the box 13. Preferably, sealing rings 137 are provided between the heating glass tube 2 and the first tube hole 1311, as well as between the heating glass tube 2 and the second tube hole 1321. The number of the heating glass tubes 2 is larger than or equal to two. In this embodiment, the number of the heating glass tubes 2 is five, and the five heating glass tubes 2 are arranged side by side in the box 13. Referring to FIG. 5, a spiral structural member 3 is provided inside the heating glass tube 2, which is preferably a spiral spring. It should be noted that the number of the heating glass tubes 2 can also be three or six, etc., so there is no any limitation to the number of the heating glass tubes 2. Those skilled in the art can set the number of the heating glass tubes 2 by themselves according to their needs. Outer surfaces of one ends of multiple heating glass tubes 2 are connected in series using a first wire to form a live wire terminal 4, and outer surfaces of the other ends of the multiple heating glass tubes 2 are connected in series using a second wire to form a neutral wire terminal 5, thereby supplying power to the superconducting material layer. The first wire and the second wire can be made of the same material or different materials. For example, both the first wire and the second wire can be made of copper or aluminum wires, or the first wire can be made of a copper wire and the second wire can be made of an aluminum wire.

The above arrangement has the following advantages: the outer shell 1 is arranged such that the box 13 is connected to the cover 14, which is more advantageous for the installation of internal components of the outer shell 1; the sealed connection can prevent water leakage; preferably, both the cover 14 and the box 13 are made of high polymer materials, and the cover 14 and the box 13 are fixed by ultrasonic welding or melting, greatly improving the sealing performance between the cover 14 and the box 13. Further, the first partition 131 forms the first water chamber 135 with the side wall on the side of the water inlet 11, and one end of the heating glass tube 2 is communicated with the first water chamber 135. The second partition 132 forms the second water chamber 136 with the side wall on the side of the outlet 12, and the other end of the heating glass tube 2 is communicated with the second water chamber 136. Cold water enters the first water chamber 135 through the water inlet 11, disperses in the first water chamber 135, and then flows into each of the heating glass tubes 2. The cold water is heated into hot water or hot steam in each of the heating glass tubes 2, which then flows into the second water chamber 136. After being collected in the second water chamber 136, the hot water or hot steam enters the clothing containing cylinder through the outlet 12 for clothing washing or caring and wrinkle removal. The heating glass tubes 2 are suspended inside the box 13 to prevent contact with the inner wall of the box 13, which would otherwise cause the temperature of the box 13 to rise and pose a risk of scalding. Multiple heating glass tubes 2 are arranged in parallel inside the box 13. During heating, users can control the number of activated heating glass tubes 2 by controlling the communication between a single heating glass tube 2 and the water chamber, making the operation more flexible. In addition, the water inlet 11 and the outlet 12 are diagonally arranged to increase the time for water to stay in the heating glass tubes 2, so that the water can be heated to completely reach a preset temperature or completely evaporated before being discharged, preventing the water that has entered from the water inlet 11 from flowing out directly from the outlet 12 through the first water chamber 135, the heating glass tubes 2 and the second water chamber 136 under pressure driving, which would otherwise cause insufficient water heating. The sealing rings 137 prevent water or steam in the water chamber from seeping back into the heating glass tubes 2, thereby further isolating water from electricity and improving safety performance. The spiral spring forms a spiral water flow channel with the inner wall of the heating glass tube 2, and water advances spirally inside the heating glass tube 2, thereby achieving spiral transmission and flow of water flow, realizing swirling heating. During this process, water continuously mixes and comes into contact with the inner wall of the heating glass tube 2, allowing water to be quickly heated into hot water or hot steam in a short period of time, and improving heating rate and efficiency without reducing the flow velocity of hot water or hot steam.

As shown in FIGS. 3 to 5, in a possible embodiment, a third partition 133 is provided inside the first water chamber 135, and a fourth partition 134 is provided inside the second water chamber 136. The third partition 133 divides the first water chamber 135 into multiple first water sub-chambers 1331, and the fourth partition 134 divides the second water chamber 136 into multiple second water sub-chambers 1341. Multiple heating glass tubes 2 are communicated in series through the first water sub-chambers 1331 and the second water sub-chambers 1341.

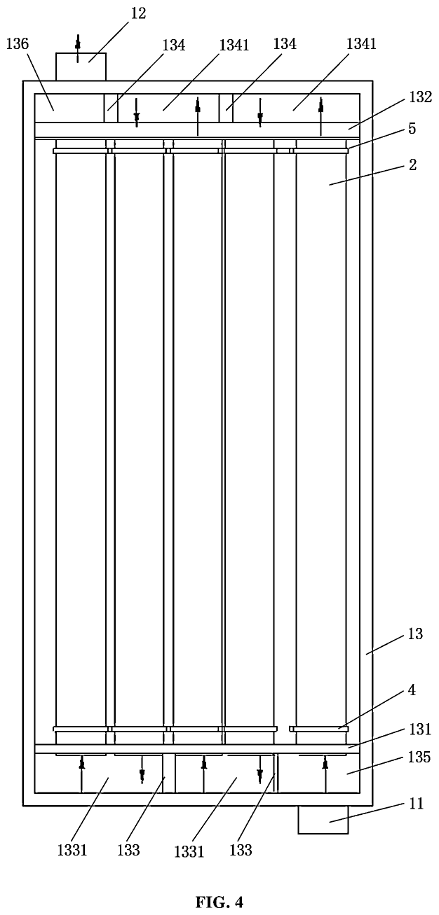

The above arrangement has the following advantages: multiple heating glass tubes 2 are arranged in parallel inside the box 13, and are communicated in series through the first water sub-chambers 1331 and the second water sub-chambers 1341, forming water flow paths connected in series, which enables the heating glass tubes 2 to be connected in parallel while the water flow paths are connected in series, thus achieving the small modularity of the heating glass tubes 2, facilitating installation, transportation, maintenance, and replacement. Referring to the flow direction of water indicated by the arrows in FIG. 3 and FIG. 4, specifically, the water entering from the water inlet 11 flows into each of the heating glass tubes 2 in sequence for heating. The first water sub-chambers 1331 and the second water sub-chambers 1341 connect multiple parallel heating glass tubes 2 in series; finally, hot water or hot steam is discharged from the outlet 12, so that the water stays in the heating glass tubes 2 for a longer time, resulting in faster heating rate of water and higher heating efficiency. During the generation of steam, due to the longer flow distance of water in the heating glass tubes 2 after the heating glass tubes 2 are connected in series, the water evaporates more completely, and the water vapor discharged from the outlet 12 contains less large water droplets, thereby improving the caring effect on the clothing. During the generation of hot water, the heating efficiency is also improved due to the longer heating time of water.

Referring to FIG. 3, in a possible embodiment, a one-way valve (not shown in the figure) communicated with the outside of the washing-drying integrated machine is arranged on the outlet 12 of the water heating device. The one-way valve is configured to discharge the residual water inside the heating glass tubes 2 out of the heating glass tubes 2 after the water heating device is powered off, thereby preventing the residual water from not being discharged in a timely manner to produce odors and bacteria when the washing-drying integrated machine is not in use for a long time.

In summary, in the water heating device of the present disclosure, multiple parallel heating glass tubes 2 are communicated with the first water sub-chambers 1331 and the second water sub-chambers 1341 arranged on the box 13, thereby connecting the multiple parallel heating glass tubes 2 in series. Compared with the heating glass tubes connected in series end to end, which requires the arrangement of circular arc segments on the heating glass tubes and which leads to high cost and is not advantageous for installation and replacement, multiple heating glass tubes 2 are connects in series in the present disclosure through the water chambers provided on the box 13, making the structure of the heating glass tubes 2 simpler, resulting in lower processing cost, and making it to install and replace. In addition, the water heating device of the present disclosure can have a dual function of generating hot water or steam by setting different heating temperatures, that is, according to the different heating temperatures, hot water or hot steam can be discharged from the outlet for washing or caring of clothing. In addition, the spiral spring inside the heating glass tube 2 guides the water to flow spirally, which improves heating efficiency and saves electricity consumption; on the basis of improving the safety performance of water heating by using the superconducting material for heating, water is separated from electricity by the heating glass tubes 2, which further improves the safety performance of the water heating device, meets the needs of users, and improves the user experience.

As stated in the first paragraph of this section, the above embodiments are only used to illustrate the principle of the present disclosure, and are not intended to limit the scope of protection of the present disclosure. Without departing from the principle of the present disclosure, those skilled in the art can adjust the above structures so that the present disclosure can be applied to more specific application scenes.

For example, in an alternative embodiment, the spiral structure member 3 can also be a non-elastic spiral structure member 3 other than the spiral spring. The spiral structure member 3 can be continuously arranged inside the heating glass tube 2, or multiple spiral structure members 3 can be interruptedly arranged inside the heating glass tube 2. In addition, the material of the spiral structure member 3 can be metal or plastic, so there is no any limitation to the specific structure of the spiral structure member 3. All of the above do not deviate from the principle of the present disclosure and therefore fall within the scope of protection of the present disclosure.

For example, in an alternative embodiment, the structure of the outer shell 1 can also be a cylindrical structure or has other shapes other than the cuboid structure. The materials of the box 13 and the cover 14 can be high polymer materials to reduce the weight of the water heating device, but this is not limiting. The box 13 and the cover 14 can also be made of aluminum alloy plates or iron plates, and they are connected by screws. Specifically, a sealing groove is provided around the edge of the box 13, and a sealing ring is provided inside the sealing groove. After the box 13 and the cover 14 are connected by screws, the edge of the cover 14 is pressed against the sealing ring, thus playing a sealing role. In addition, the numbers of the water inlet 11 and the outlet 12 can each be one or multiple, and those skilled in the art can set them as needed. The water inlet 11 and the outlet 12 can protrude from the outer surface of the outer shell 1, or they can be directly arranged on the outer surface of the outer shell 1. The water inlet 11 and the outlet 12 can also be arranged on two adjacent side walls of the box 13 respectively. The shapes of the water inlet 11 and the outlet 12 can be set to be circular or square, etc. These adjustments do not deviate from the principle of the present disclosure, and therefore fall within the scope of protection of the present disclosure.

For example, in an alternative embodiment, the heating tube can also be a ceramic tube or a plastic tube other than the heating glass tube 2. The diameter of multiple heating tubes can be the same or different, or the diameter of each heating tube gradually increases or decreases in the direction of water flow. Therefore, there is no any limitation to the material and diameter of the heating tube, as long as the heating tube can transfer the heat of the superconducting material layer to the interior of the heating tube. These adjustments do not deviate from the principle of the present disclosure, and therefore fall within the scope of protection of the present disclosure.

For example, in an alternative embodiment, the water path can also be formed by connecting the heating glass tubes 2 in series end to end. As to the multiple heating glass tubes 2, glass tubes of the same shape can be connected end to end to form pipelines connected in series, or glass tubes of different shapes can be connected end to end to form pipelines connected in series. Two ends of the pipelines connected in series can be directly connected to the water inlet 11 and the outlet 12 respectively, or they can be communicated with the first water chamber 135 and the second water chamber 136 respectively. In addition, the shape of the heating glass tube 2 can be a straight tube, or a spiral tube that matches the shape of the spiral structural member 3, or an S-shaped tube. Therefore, there is no any limitation to the shape of the heating glass tube 2. These adjustments do not deviate from the principle of the present disclosure, and therefore fall within the scope of protection of the present disclosure.

For example, in an alternative embodiment, the thickness of the superconducting material layer on the heating glass tube 2 gradually decreases in the direction of water flow. Specifically, the thickness of the superconducting material layer can be varied as needed. The thickness of the superconducting material layer varies on different sections of the heating glass tube 2, resulting in different water heating efficiencies at different positions on the heating glass tube 2. As the water flows, the flow velocity of water becomes slower and slower under the action of friction, which means that the contact time between the water flow and the heating glass tube 2 becomes longer and longer. Correspondingly, the thickness of the superconducting material layer on the heating glass tube 2 gradually decreases, so that the heating efficiency of water at various positions inside the heating glass tube 2 is consistent, making the water temperature easier to control. These adjustments do not deviate from the principle of the present disclosure, and therefore fall within the scope of protection of the present disclosure.

For example, in an alternative embodiment, one end of the heating glass tube 2 enters the first water chamber 135 through the first tube hole 1311, and the other end of the heating glass tube 2 enters the second water chamber 136 through the second tube hole 1321. These adjustments do not deviate from the principle of the present disclosure, and therefore fall within the scope of protection of the present disclosure.

Hitherto, the technical solutions of the present disclosure have been described in connection with the preferred embodiments shown in the accompanying drawings, but it is easily understood by those skilled in the art that the scope of protection of the present disclosure is obviously not limited to these specific embodiments. Without departing from the principles of the present disclosure, those skilled in the art can make equivalent changes or replacements to relevant technical features, and all the technical solutions after these changes or replacements will fall within the scope of protection of the present disclosure.

What is claimed is:

1. A water heating device, wherein the water heating device comprises an outer shell, on which a water inlet and an outlet are provided; a heating tube is provided inside the outer shell, a superconducting material layer is provided on an outer surface of the heating tube, and the water inlet and the outlet are respectively communicated with two ends of the heating tube.

2. The water heating device according to claim 1, wherein the outer shell comprises a box and a cover that can open and close the box; the water inlet is arranged on one side wall of the box, the outlet is arranged on the other side wall opposite to the water inlet, and the heating tube is arranged inside the box.

3. The water heating device according to claim 1, wherein a spiral structural member is provided inside the heating tube.

4. The water heating device according to claim 2, wherein a first partition and a second partition are provided inside the box; the first partition forms a first water chamber with the side wall on the side of the water inlet, and the second partition forms a second water chamber with the side wall on the side of the outlet; the heating tube is arranged between the first partition and the second partition, with a first tube hole being provided on the first partition and a second tube hole being provided on the second partition; and the two ends of the heating tube are respectively arranged in the first tube hole and the second tube hole.

5. The water heating device according to claim 4, wherein the heating tube is a heating glass tube, the number of the heating glass tube is multiple, and the multiple heating glass tubes are arranged side by side inside the box.

6. The water heating device according to claim 5, wherein a third partition is provided inside the first water chamber, and a fourth partition is provided inside the second water chamber; the third partition divides the first water chamber into multiple first water sub-chambers, the fourth partition divides the second water chamber into multiple second water sub-chambers, and the multiple heating glass tubes are communicated in series through the first water sub-chambers and the second water sub-chambers.

7. The water heating device according to claim 5, wherein one ends of the multiple heating glass tubes are connected in series using a first wire to form a live wire terminal, and the other ends of the multiple heating glass tubes are connected in series using a second wire to form a neutral wire terminal.

8. The water heating device according to claim 4, wherein sealing rings are provided between the first tube hole and the heating tube, as well as between the second tube hole and the heating tube.

9. The water heating device according to claim 4, wherein the water inlet and the outlet are diagonally arranged.

10. The water heating device according to claim 3, wherein the spiral structural member is a spiral spring.
